(19) United States
(12) Patent Application Publication
(10) Pub. No.: US 2013/0180707 A1
(43) Pub. Date: Jul. 18, 2013

(54) Rugged Coiled Tubing Connector

(71) Applicant: Robert Bucher, Houston, TX (US)

(72) Inventor: Robert Bucher, Houston, TX (US)

(21) Appl. No.: 13/510,029

(22) PCT Filed: Nov. 16, 2010
(86) PCT No.: PCT/IB10/55199

§ 371 Date: Jan. 23, 2013

Related U.S. Application Data
(60) Provisional application No. 61/261,924, filed on Nov. 17, 2009.

(51) Int. Cl. E21B 17/04; E21B 17/20; B23P 19/04

(52) U.S. Cl. CPC E21B 17/04; B23P 19/04; E21B 17/20
USPC 166/242.2; 29/428

(57) ABSTRACT

The current application discloses coiled tubing assemblies and methods of connecting coiled tubing with downhole devices. In an exemplary embodiment, the assembly comprises a coiled tubing, a downhole device for performing an operation in a subterranean wellbore, a connector that mechanically connects the coiled tubing to the downhole device; and a sealing device that seals the connection between the coiled tubing and the connector. The sealing device is substantially free of axial tensions caused by a weight of the downhole device.

### FIELD OF THE APPLICATION

The current application is generally related to coil tubing connectors for use in the field of oil and gas exploration or production, although embodiments disclosed herein may be applicable in other fields as well.

### BACKGROUND

The statements in this section merely provide background information related to the present disclosure and may not constitute prior art.

For many coiled tubing operations performed in a wellbore penetrating a subterranean formation, a coiled tubing connector is often used to connect a string of coiled tubing to a subsequent downhole device such as a bottom hole assembly (BHA), a downhole tool (e.g. a jet nozzle, a drilling bit, a valve, etc.), or an additional string of coiled tubing. The downhole device can then be used to perform a variety of oilfield operations to the subterranean formation such as drilling, testing, logging, stimulating, and so on.

Typically, coiled tubing connectors either attach and seal on the external side of a coiled tubing, or attach and seal on the internal side of a coiled tubing. For externally attached and sealed connectors, the outside diameter (OD) of the connector is often undesirably large, precluding the connector from fitting within some wellbore diameters or passing through some wellhead assemblies; for internally attached and sealed connectors, the inner diameter (ID) of the connector is often undesirably small, therefore taking away valuable fluid flow through area from the coiled tubing assembly.

Moreover, seals in traditional coiled tubing connectors are often susceptible to wear and tear due to the axial tensions exerted on the seals by the weight of the downhole devices. By way of “axial tensions”, it is referred to the mechanical and/or frictional forces caused by the weight of the downhole devices on the connector along the longitudinal axis of the coiled tubing-connector-downhole device assembly. An example is shown in FIG. 1 of the current application, marked as axis “Y”. Traditionally, when a coiled tubing connector either attaches and seals on the external side of a coiled tubing, or attaches and seals on the internal side of a coiled tubing, a substantial amount of the axial tension is taken by the mechanical connections between the connector and the coiled tubing as well as the connector and the downhole device. Nevertheless, a significant amount of the axial tension is shared by the seal of the connector, which causes undesirable fatigue to the seal.

Accordingly, a need exists for a coiled tubing connector provided by the various embodiments of the present application.

### SUMMARY

According to one aspect, there is provided an assembly which comprises a coiled tubing, a downhole device for performing an operation in a subterranean wellbore, a connector that mechanically connects the coiled tubing to the downhole device; and a sealing device that seals the connection between the coiled tubing and the connector. The sealing device is substantially free of axial tensions caused by the weight of the downhole device. In some cases, the connector mechanically connects to one of the outside and the inside of the coiled tubing and the sealing device is in sealing contact with another of the outside and the inside of the coiled tubing. In one example, the connector mechanically connects to the outside of the coiled tubing and the sealing device is in sealing contact with the inside of the coiled tubing.

In some cases, the connector has a stepped surface extending substantially radially from a side surface (such as the inner side wall) of the connector so that a gap can be formed between the stepped surface and the lower end of the coiled tubing. In one example, the sealing device has a protrusion extending substantially radially from a side surface (such as the outside wall) of the sealing device and lodges into the gap between the stepped surface of the connector and the lower end of the coiled tubing. According to another example of the application, the sealing device is a simple sealing mechanism such as an o-ring or Grayloc type seal ring that is located within the gap between the first stepped surface of the connector and the lower end of the coiled tubing. The separation of the sealing device from the mechanical connector reduces the negative impacts on the O.D. and/or I.D. of the coiled tubing assembly and increases the lifespan of the seal and the assembly.

According to another aspect of the application, there is provided a method of connecting a coiled tubing with a downhole device. The method comprises providing a coiled tubing; mechanically attaching a connector to the coiled tubing; providing a seal between the connector and the coiled tubing, said seal is substantially free of axial tensions caused by a weight of the downhole device; and mechanically attaching the connector with the downhole device.

The downhole device described herein can be an additional string of coiled tubing, a downhole tool such as a drill bit, a bottom hole assembly (BHA), or any other devices that can be connected to the distal end of a coiled tubing assembly for performing an operation in a subterranean wellbore.

### BRIEF DESCRIPTION OF THE DRAWINGS

These and other features and advantages will be better understood by reference to the following detailed description when considered in conjunction with the accompanying drawings.

FIG. 1 is a cross sectional view of a coiled tubing assembly according to an embodiment of the current application.

FIG. 2 is a cross sectional view of a coiled tubing assembly according to another embodiment of the current application.

FIG. 3 is a cross sectional view of a coiled tubing assembly according to a further embodiment of the current application.

### DETAILED DESCRIPTION OF SOME ILLUSTRATIVE EMBODIMENTS

As used herein, terms such as “up”, “down”, “upper”, “lower”, “top” and “bottom” and other like terms indicate relative positions of the various components of the coiled tubing connector and coiled tubing assembly of the present application with the coiled tubing, connector, and assembly vertically oriented as shown in the drawings. However, it should be borne in mind that the coiled tubing connector and assembly of the present application is designed for employment in wells having wellbore sections that are oriented vertically, that are highly deviated from the vertical, or may be oriented horizontally. Also, the terms “coiled tubing” or “tubing”, as used herein, are intended to mean tubing strings of any character, including coiled tubing or jointed tubing, which are used to convey bottom hole assemblies (BHAs), downhole tools, or other well treatment tools to selected zones or intervals within wells.

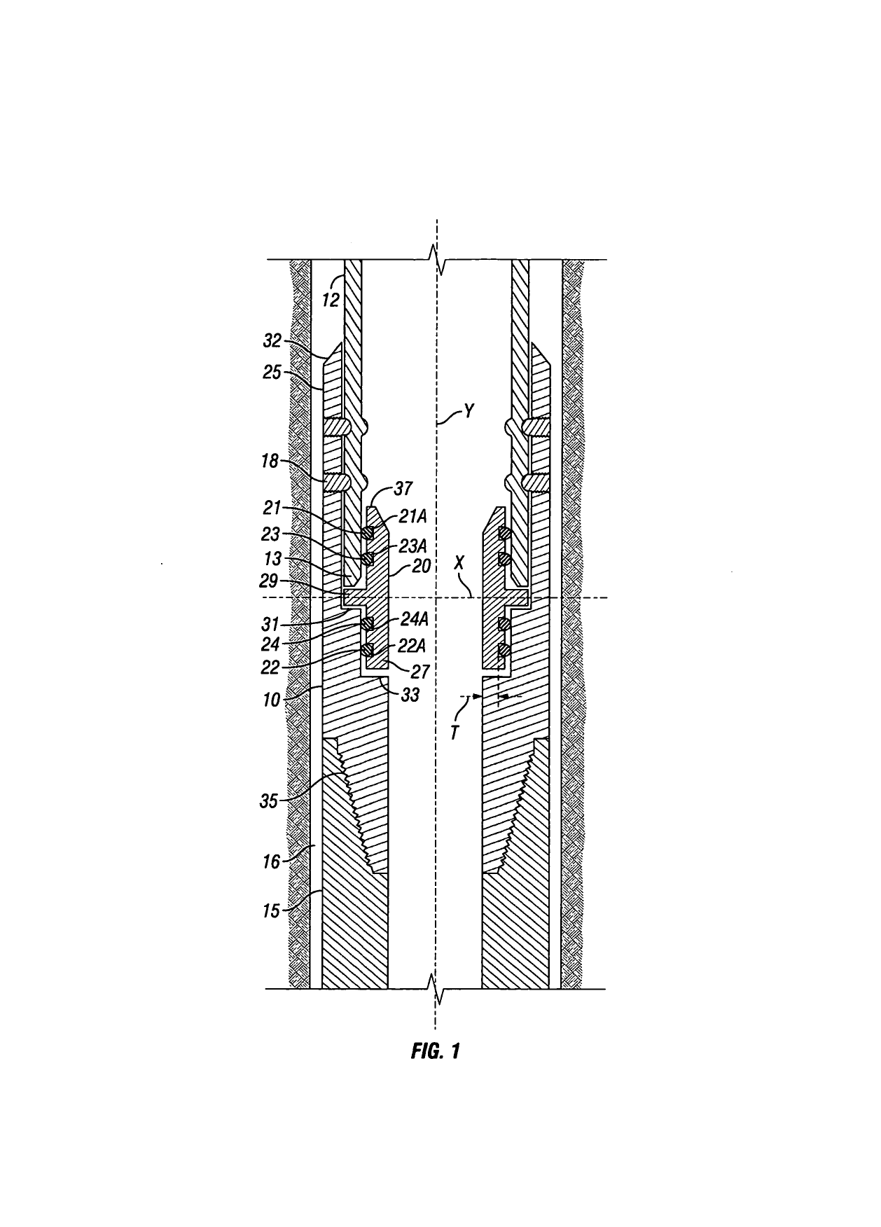

As shown in FIG. 1, one embodiment of the present application includes a coiled tubing connector 10 for connecting a string of coiled tubing 12 to a bottom hole assembly 15 for performing an operation in a subterranean wellbore 16. In this embodiment, an upper end 25 of the connector 10 mechanically attaches to one side (such as the external side) of the coiled tubing 12; a sealing device 20 is provided on an opposite side (such as the internal side) of the coiled tubing 12; and a lower end 35 of the connector 10 mechanically attaches to the bottom hole assembly 15. In the illustrated embodiment, the coiled tubing 12, the connector 10, and the sealing device 20 are all substantially cylindrical in shape, but it should be noted that other shapes are also possible. FIG. 1 shows the cross sectional view of an exemplary coiled tubing-connector-tool assembly.

The upper end 25 of the connector 10 can be mechanical connected to the coiled tubing 12 by any appropriate attachment mechanism such as screws, threads, dimple connection, slips, etc. In the illustrated embodiment in FIG. 1, one or more mechanical connectors 18, such as set screws, are provided to connect the coiled tubing 12 with the upper end 25 of the connector 10. The lower end 35 of the connector 10 may be connected to a bottom hole assembly 15 by screws, threads, dimple connection, slips, or by any other appropriate attachment mechanism.

In one embodiment, a sealing device 20 is provided at an opposite side of the coiled tubing 12 from the connector 10. That is, if the connector 10 mechanically attaches to the outside surface of the coiled tubing 12, the sealing device 20 forms a sealing contact with the inner surface of the coiled tubing 12 (as shown in FIG. 1); if the connector 10 mechanically attaches to the inner surface of the coiled tubing 12, the sealing device 20 makes sealing contact with outside surface of the coiled tubing 12 (not shown).

In FIG. 1, the sealing device 20 is positioned near the juncture where the coiled tubing 12 is connected to the connector 10, therefore preventing fluid from passing through the juncture from the inside to the outside of the coiled tubing or vice versa. In the illustrated embodiment, the sealing device 20 is substantially cylindrical in shape, with an upper end 37 that is located proximate to the coiled tubing 12 and a lower end 27 that is located proximate to the bottom of the wellbore. A protrusion 29 can be provided approximately half way between the upper end 37 and distal end 27 of the seal assembly, and extends generally radially from the external surface of the cylindrically shaped sealing device 20, in a plane labeled as “X” in FIG. 1. Plane “X” is substantially perpendicular to the longitudinal axis “Y” of the coiled tubing-connector-BHA assembly. When properly assembled, the protrusion 29 is inserted into a space formed between the bottom end 13 of the coiled tubing 12 and a first stepped surface 31 formed on the inner wall of the connector 10. Therefore, the protrusion 29 can securely lodge the sealing device 20 between the coiled tubing 12 and the first stepped surface 31 of the connector 10. Alternatively, or in combination with the protrusion 29, the connector 10 may have a second stepped surface 33 formed on the inner wall of the connector 10. In this embodiment, the second stepped surface 33 is underneath the lower end 27 of the sealing device 20, so that the lower end 27 of the sealing device 20 sits on top of the second stepped surface 33 of the connector 10 and receives upward supports from the second stepped surface 33 along the longitudinal axis “Y” as shown in FIG. 1.

In FIG. 1, the sealing device 20 comprises one or more o-rings 21, 22, 23, 24 seated inside one or more grooves 21A, 22A, 23A, 24A formed on the external surface of the sealing device 20. In some cases, one or more of the o-rings 21, 23 may form sealing contacts with the inner surface of the coiled tubing 12, therefore prevent fluids from passing through the junction between the sealing device 20 and the coiled tubing 12. In some cases, one or more of the o-rings 22, 24 may form sealing contacts with the inner surface of the connector 10, therefore prevent fluids from passing through the junction between the sealing device 20 and the connector 10. In some further cases, seals are formed between both the sealing device 20 and the coiled tubing 12 and between the seal assembly 20 and the connector 10, as illustrated in FIG. 1 as an example.

In FIG. 1, the sealing device 20 functions to seal fluids from passing through the junction of the coiled tubing 12 and the connector 10, while the mechanical connectors 18 function to connect the connector 10 to the coiled tubing 12 to support the tensile forces created by the weight of the coiled tubing and/or the bottom hole assembly. If the sealing device 20 were on the same side of the coiled tubing 12 as the mechanical connectors 18, then the sealing device 20 would have to share in holding the tensile forces acting on the connector 10. In order to accomplish this, the amount of material or thickness T behind the o-ring grooves 21A, 22A, 23A, 24A, of the sealing device 20 would have to be increased to avoid the creation of a tensile weakpoint in the connector 10. This added thickness T behind the o-ring grooves produces a sealing device with an undesirably small ID in situations where the connector seals internally to the coiled tubing, thus limiting fluid flow area across the connector; or produces a seal assembly with an undesirably large OD in situations where the connector seals externally to the coiled tubing. By separating the sealing function from the mechanical connectors, embodiments of the present application produce a coiled tubing connector with a minimized OD and a maximized ID.

Furthermore, when the sealing device 20 is substantially free of the tensile forces created by the weight of the coiled tubing and the bottom hole assembly along the axial direction of the coiled tubing-connector-BHA assembly (“Y” axis in FIG. 1), the wear and tear of the sealing mechanisms such as the o-rings 21, 22, 23, 24 will be significantly reduced. The fatigue of the sealing device 20 will be decreased and the useful life of the sealing device 20 will be increased.

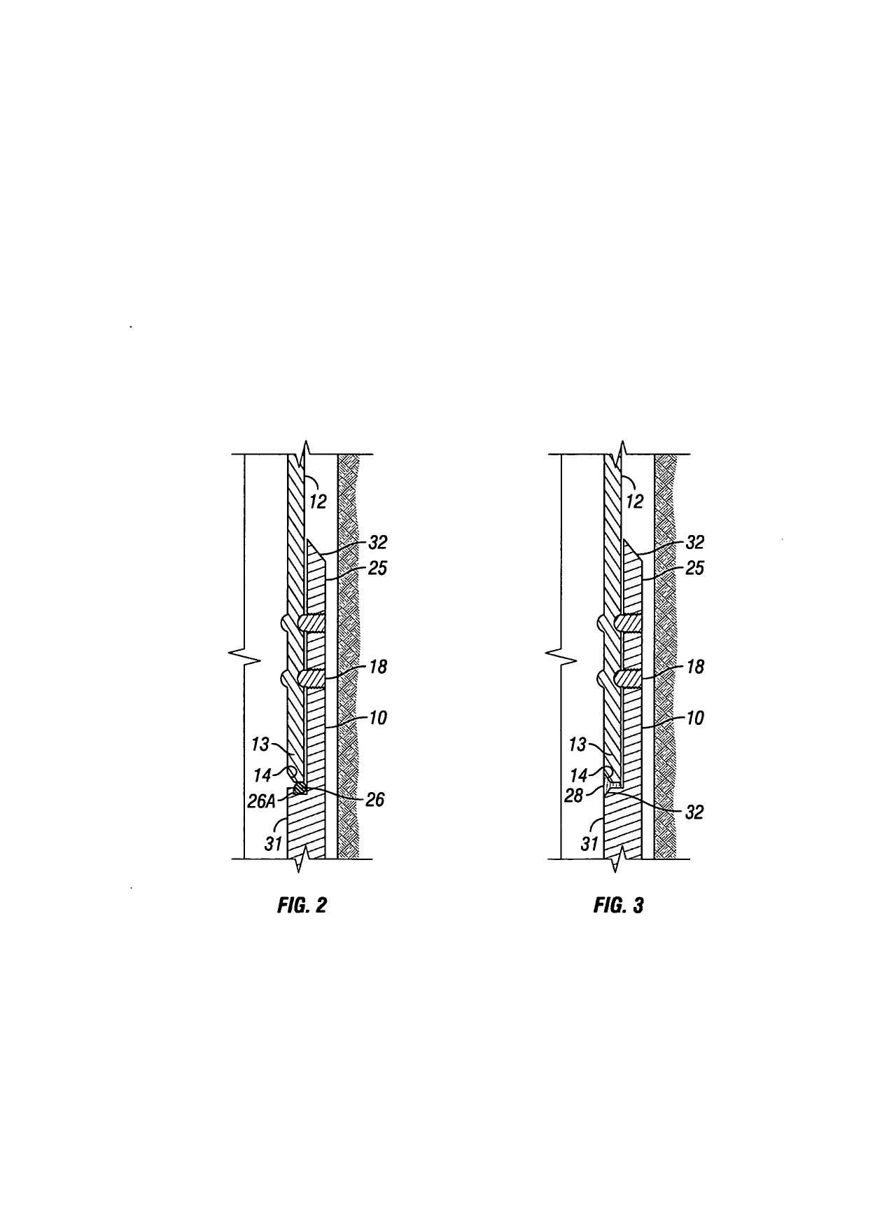

Alternatives to the above-described sealing device 20 are also possible. For example, the sealing device can be simplified to an o-ring 26 sitting in a groove 26A formed in the first stepped surface 31 of the connector, as shown in FIG. 2. The first stepped surface 31 extends generally inwardly from the inner surface of the connector 10 and is located substantially underneath the lower end 13 of the coiled tubing 12. Therefore, the upper surface of the first stepped surface 31 is substantially opposite to the bottom surface of the lower end 13 of the coiled tubing 12. When the sealing device sits inside a groove formed in the first stepped surface 31 and is in sealing contact with the lower end of the coiled tubing 12, the second stepped surface 33 of the connector 10 as illustrated in FIG. 1 above can be eliminated, therefore further increasing the inner diameter (ID) of the coiled tubing-connector-tool assembly.

In a further example, as shown in FIG. 3, a Grayloc type seal ring 28 can be employed as the sealing device between the coiled tubing 12 and the connector 10. In this example, the Grayloc type seal ring 28 is place at the gap formed between the lower end 13 of the coiled tubing 12 and the first stepped surface 31 of the connector 10. In some cases, the lower end 13 of the coiled tubing 12 comprises a first slanted surface 14, tapering generally downwardly from the inner surface of the coiled tubing towards the bottom surface of the lower end 13 of the coiled tubing 12. In some other cases, a second slanted surface 32 is formed on the first stepped surface 31 of the connector 10. In some further cases, there are both a first slanted surface 14 on the lower end 13 of the coiled tubing 12 and a second slanted surface 32 on the first stepped surface 31 of the connector 10. The two slanted surfaces 31, 32 form a trapezoid-shaped cavity to accommodate the seal ring. The slanted surface ensures the secured lodging of the seal ring in the gap during the assembling process.

The initially assembled seal can be further improved during operation. This is because the Grayloc type seal ring is elastically deformable. When fluids are passed through the coiled tubing-connector-tool assembly under high pressure, the seal ring 29 can be further pressed into the gap between the lower end 13 of the coiled tubing 12 and the first stepped surface 31 of the connector 10. This process is facilitated by the first and/or second slanted surfaces 14, 32 formed on the lower end 13 of the coiled tubing 12 and the first stepped surface 31 of the connector 10, respectively.

It should be noted that although embodiments of the present application focus on the connector 10 being mechanically connected to an external surface of a string of coiled tubing 12, and fluidly sealed to an internal surface or a lower end of a coiled tubing, in alternative embodiments the connector may be mechanically connected to an internal surface of the coiled tubing 12, and fluidly sealed to an external surface or a lower end of a string of coiled tubing. Further variations are also possible.

The preceding description has been presented with reference to some illustrative embodiments of the current application. Persons skilled in the art and technology to which this application pertains will appreciate that alterations and changes in the described structures and methods of operation can be practiced without meaningfully departing from the principle, and scope of this application. Accordingly, the foregoing description should not be read as pertaining only to the precise structures described and shown in the accompanying drawings, but rather should be read as consistent with and as support for the following claims, which are to have their fullest and fairest scope.

We claim:

1. An assembly comprising:
a coiled tubing;
a downhole device for performing an operation in a subterranean wellbore;
a connector that mechanically connects the coiled tubing to the downhole device; and
a sealing device that seals a connection between the coiled tubing and the connector;
wherein said sealing device is substantially free of axial tensions caused by a weight of the downhole device.

2. The assembly of claim 1, wherein the connector mechanically connects to one of an outside and an inside of the coiled tubing and the sealing device is in sealing contact with another of the outside and the inside of the coiled tubing.

3. The assembly of claim 2, wherein the connector mechanically connects to the outside of the coiled tubing and the sealing device is in sealing contact with the inside of the coiled tubing.

4. The assembly of claim 3, wherein the connector is substantially free of sealing mechanism.

5. The assembly of claim 3, wherein the connector comprises a first end that mechanically connects to the coiled tubing and a second end that mechanically connects to the downhole device.

6. The assembly of claim 5, wherein the first end mechanically connects to the coiled tubing by one of a screw, a dimple, a thread, and a slip.

7. The assembly of claim 5, wherein the second end mechanically connects to the coiled tubing by one of a screw, a dimple, a thread, and a slip.

8. The assembly of claim 1, wherein the connector has a first stepped surface extending substantially radially from a side surface of the connector to form a gap with a lower end of the coiled tubing.

9. The assembly of claim 8, wherein the sealing device has a proximate end, a distal end, and a protrusion extending substantially radially from a side surface of the sealing device at a location between said proximate end and said distal end.

10. The assembly of claim 9, wherein the protrusion of the sealing device lodges into the gap between the first stepped surface of the connector and the lower end of the coiled tubing.

11. The assembly of claim 10, wherein the connector has a second stepped surface extending substantially radially from a side surface of the first stepped surface, said distal end of the sealing device sits on top of said second stepped surface of the connector.

12. The assembly of claim 9, wherein at least one sealing mechanism is provided at the proximate end of the sealing device to form a seal between the sealing device and the coiled tubing.

13. The assembly of claim 9, wherein at least one sealing mechanism is provided at the distal end of the sealing device to form a seal between the sealing device and the connector.

14. The assembly of claim 8, wherein the sealing device is a sealing mechanism located within the gap between the first stepped surface of the connector and the lower end of the coiled tubing.

15. The assembly of claim 14, wherein the sealing mechanism is an o-ring.

16. The assembly of claim 14, wherein the sealing mechanism is a Grayloc type seal ring.

17. The assembly of claim 8, wherein the lower end of the coiled tubing comprises a first slanted surface.

18. The assembly of claim 8, wherein the first stepped surface of the connector comprises a second slanted surface.

19. The assembly of claim 1, wherein the downhole device is an additional string of coiled tubing, a downhole tool, or a bottom hole assembly (BHA).

20. A method of connecting a coiled tubing with a downhole device, said method comprising:
providing the coiled tubing;
mechanically attaching a connector to the coiled tubing;
providing a seal between the connector and the coiled tubing, said seal is substantially free of axial tensions caused by a weight of the downhole device; and
mechanically attaching the connector with the downhole device.

21. The method of claim 20, wherein the downhole device is an additional string of coiled tubing, a downhole tool, or a bottom hole assembly (BHA).
